(19) United States
(12) Patent Application Publication
(10) Pub. No.: US 2025/0390164 A1
(43) Pub. Date: Dec. 25, 2025

(54) ELECTRONIC APPARATUS, CONTROL METHOD, AND STORAGE MEDIUM FOR DISPLAYING A REFERENCE HAND COMPUTER GRAPHIC

(71) Applicant: CANON KABUSHIKI KAISHA, Tokyo (JP)

(72) Inventor: MASAKI MORIKAWA, Kanagawa (JP)

(21) Appl. No.: 19/225,866

(22) Filed: Jun. 2, 2025

(30) Foreign Application Priority Data
Jun. 19, 2024 (JP) 2024-099181

(51) Int. Cl. G06F 3/01; G06F 3/042

(52) U.S. Cl. CPC G06F 3/011; G06F 3/0425

(57) ABSTRACT

An electronic apparatus includes an imaging unit, a display, at least one processor, and at least one memory. The at least one memory stores instructions for causing the at least one processor and the at least one memory to estimate a position and orientation of a tool used by a user based on an image captured by the imaging unit, acquire a movement of a hand of a person other than the user in a case where the tool is used by the person, and display a computer graphic (CG) for a hand on the display unit based on the position and orientation and the movement. The CG for the hand is displayed at a position that does not overlap with a hand of the user on the tool.

### BACKGROUND

### Field of the Disclosure

The present disclosure relates to an electronic apparatus, in particular, an electronic apparatus for displaying a computer graphic (CG) of a hand as a reference.

### Description of the Related Art

Conventionally, a learning method using computer graphics (CG) has been known as a method for learning a musical instrument that is difficult to handle. For example, Japanese Patent Application Laid-Open No. 2011-215856 discusses the display of CG used as a reference for a user wearing a head-mounted display (HMD).

However, the conventional technology discussed in Japanese Patent Application Laid-Open No. 2011-215856 has an issue in that reference hand movements using the CG can be displayed but the position and effect of the CG display cannot be appropriately controlled for the situation or intended purpose of the user.

### SUMMARY

In order to solve the above described issues, an electronic apparatus according to the present disclosure includes an imaging unit, a display unit, at least one processor, and at least one memory. The at least one memory stores instructions for causing the at least one processor and the at least one memory to estimate a position and orientation of a tool used by a user based on an image captured by the imaging unit, acquire a movement of a hand of a person other than the user in a case where the tool is used by the person, and display a computer graphic (CG) for a hand on the display unit based on the position and orientation and the movement. The CG for the hand is displayed at a position that does not overlap with a hand of the user on the tool.

Further features of the present disclosure will become apparent from the following description of exemplary embodiments with reference to the attached drawings.

### BRIEF DESCRIPTION OF THE DRAWINGS

FIG. 1 is a schematic diagram illustrating a system configuration according to a first exemplary embodiment.

FIG. 2 is a block diagram illustrating an example of a hardware configuration of an image display apparatus.

FIG. 3 is a block diagram illustrating an example of a hardware configuration of an imaging apparatus.

FIG. 4 is a diagram illustrating a functional configuration of a system according to the first exemplary embodiment.

FIG. 5 is a flowchart illustrating a procedure of the image display apparatus.

FIG. 6 is a flowchart illustrating a position and orientation estimation process.

FIG. 7 is a flowchart illustrating a computer graphics (CG) rendering process for each operating mode.

FIG. 8 is a flowchart illustrating a rendering process corresponding to an operating mode 1.

FIG. 9 is a flowchart illustrating a rendering process corresponding to an operating mode 2.

FIG. 10 is a flowchart illustrating a rendering process corresponding to an operating mode 3.

FIG. 11 is a flowchart illustrating a process including an operation option of the operating modes 1 and 2.

FIG. 12 is a flowchart illustrating a procedure of the imaging apparatus.

FIG. 13 is a diagram illustrating an example of an operating mode setting screen.

FIG. 14 is a diagram illustrating an example of an operating mode change setting screen.

FIG. 15 is a table presenting details of the control performed to render at positions close to hands of a user.

FIG. 16 illustrates a display example corresponding to the first row in FIG. 15.

FIG. 17 illustrates a display example corresponding to the second row in FIG. 15.

FIG. 18 illustrates a display example corresponding to the third row in FIG. 15.

FIG. 19 illustrates a display example corresponding to the fourth row in FIG. 15.

FIG. 20 illustrates a display example corresponding to the fifth row in FIG. 15.

FIG. 21 illustrates a display example corresponding to the sixth row in FIG. 15.

FIG. 22 illustrates a display example corresponding to the seventh row in FIG. 15.

FIG. 23 illustrates display examples corresponding to the eighth to tenth rows in FIG. 15.

FIG. 24 illustrates display examples in a case where control is performed to render at positions one octave above and below.

FIG. 25 illustrates a display example in a case where control is performed to separate overlapping hands and display the separated hands individually.

FIG. 26 illustrates display examples in a case where normal display is performed.

FIG. 27 illustrates a display example in a case where control is performed to display a hand within a line of sight with priority.

FIG. 28 is a schematic diagram illustrating a system configuration according to a second exemplary embodiment.

FIG. 29 is a diagram illustrating a functional configuration of a system according to the second exemplary embodiment.

FIG. 30 is a flowchart illustrating a rendering process corresponding to the operating mode 1.

FIG. 31 is a flowchart illustrating a rendering process corresponding to the operating mode 2.

FIG. 32 is a flowchart illustrating a rendering process corresponding to the operating mode 3.

FIG. 33 is a diagram illustrating an example of an operating mode setting screen.

FIG. 34 illustrates display examples in a case where control for rendering at positions close to the hands of a user is performed.

FIG. 35 illustrates display examples in a case where control for rendering at a position at a predetermined distance is performed.

FIG. 36 illustrates a display example in a case where normal display is performed.

FIG. 37 illustrates a display example in a case where control is performed to separate overlapping hands and display the separated hands individually.

FIG. 38 illustrates a display example in a case where control is performed to display a hand within a line of sight with priority.

### DESCRIPTION OF THE EMBODIMENTS

A first exemplary embodiment of the present disclosure will be described in detail with reference to the drawings.

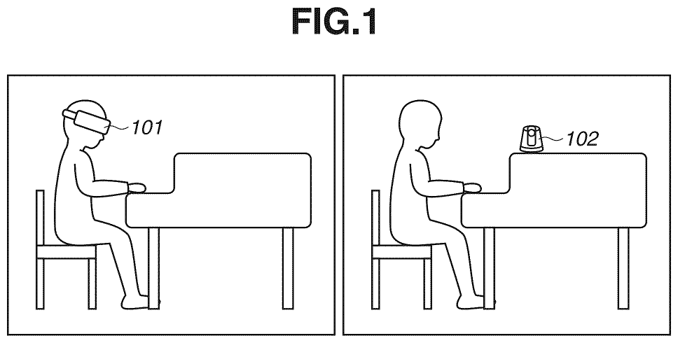

FIG. 1 is a schematic diagram illustrating an example of a system configuration according to the first exemplary embodiment. This system includes an image display apparatus 101 and an imaging apparatus 102.

The image display apparatus 101 includes a display unit and an imaging unit and is capable of communicating with the imaging apparatus 102 via wireless communication. By acquiring a video of eyes of a user observing the display unit, a line of sight of the user can be detected. Further, a tool usage operation, such as a fingering analysis result received from the imaging apparatus 102, is acquired, undergoes display control suitable for the user, and is then output to the display unit. This enables the user to use the tool while receiving an appropriate instruction.

An example of the image display apparatus 101 is a head-mounted display (HMD). The HMD is a display apparatus that is worn on the head during use. Since the HMD can directly display an image in the field of view of the user, it is suitable for augmented reality (AR) and virtual reality (VR) applications. However, this is not a limitation, and other electronic apparatuses, such as tablets or smartphones, with a similar function may also be used.

The imaging apparatus 102 is capable of communicating with the image display apparatus 101 and captures an image of fingering of a musical instrument player or an instructor using an imaging unit. The fingering and movements of the musical instrument player are analyzed from the acquired video, and the analysis result is transmitted to the image display apparatus 101. This enables the user to refer to the actual fingering of the musical instrument player.

Further, the imaging apparatus 102 may include a display unit, such as a liquid crystal display, and an operation member, such as a shutter button. The display unit can be used to view a video being captured, and the operation member can be used to start and stop imaging.

Examples of the imaging apparatus 102 include a digital camera, a video camera, and a smartphone. These apparatuses are capable of high-resolution imaging and are easy to move and install, and thus can be used in various situations. However, these are not limited thereto.

In this system, the user uses a keyboard musical instrument as a tool and learns how to play the musical instrument. Specifically, a reference hand computer graphic (CG) is overlaid onto live video of the keyboard of the musical instrument and displayed. This enables the user to learn a correct way to play the musical instrument by visually checking the reference fingering.

The CG of the fingering on the musical instrument analyzed by the imaging apparatus 102 is aligned with the actual position of the user on the musical instrument, undergoes rendering control, with a rendering effect applied based on a setting configured by the user, and is then output to the display unit of the image display apparatus 101. The user plays the musical instrument while viewing the CG overlaid on the actual musical instrument through the display unit. This enables efficient skill acquisition through visual feedback.

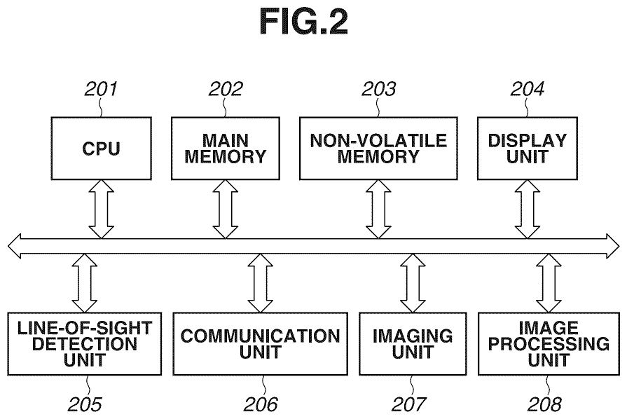

FIG. 2 is a block diagram illustrating an example of a hardware configuration of the image display apparatus 101. The image display apparatus 101 includes the following components.

A central processing unit (CPU) 201 is a central processing unit configured to execute a program recorded in a non-volatile memory 203 and realize various processes described below. Specifically, it controls line-of-sight detection of the user, display, and communication processing.

The non-volatile memory 203 is an electrically erasable and recordable memory (e.g., flash read-only memory (flash-ROM)) and stores a program and a constant number necessary for the operation of the CPU 201. In the present exemplary embodiment, a computer program for executing various flowcharts described below is stored.

A main memory 202 uses, for example, a random access memory (RAM), and constant and variable numbers necessary for the operation of the CPU 201 and a program read from the non-volatile memory 203 are loaded into the main memory 202.

A display unit 204 is a display panel configured to display an image and various types of information and uses a liquid crystal display (LCD) or an organic electroluminescent (organic EL) panel. The user views a CG overlaid on actual video and various types of information through the display unit 204.

A line-of-sight detection unit 205 includes a sensor and a camera for line-of-sight detection and detects the line of sight of the user observing the display unit 204. The detected line-of-sight information is used to specify the gaze point of the user and control the displayed content. For example, in a case where the user is gazing at a specific key, information related to the key may be highlighted and displayed.

A communication unit 206 connects to the imaging apparatus 102 and the Internet using a communication unit, such as a wireless local area network (wireless LAN) or Bluetooth®, and transmits and receives a video signal, an audio signal, and a control signal. The communication unit 206 is capable of transmitting an image (including a live-view image) captured by an imaging unit 207 and receiving an image and information from an external device. Further, a tool usage operation such as a fingering analysis result is received from the imaging apparatus 102 and acquired.

The imaging unit 207 is an image sensor configured to convert an optical image into an electrical signal and is composed of a charge-coupled device (CCD) or complementary metal-oxide-semiconductor (CMOS) sensor. A video is captured from a viewpoint of the user, and the captured video is transmitted to an image processing unit 208. This makes it possible to display the actual video with the CG overlaid thereon.

The image processing unit 208 performs predetermined image processing, such as pixel interpolation, resizing, and color conversion, on the image data acquired from the imaging unit 207. Further, predetermined computation processing is performed using the image data. The CPU 201 performs exposure control and ranging control based on the computation results from the image processing unit 208, and auto-focus (AF) processing and auto-exposure (AE) processing are performed. This makes it possible to acquire the best possible video at all times.

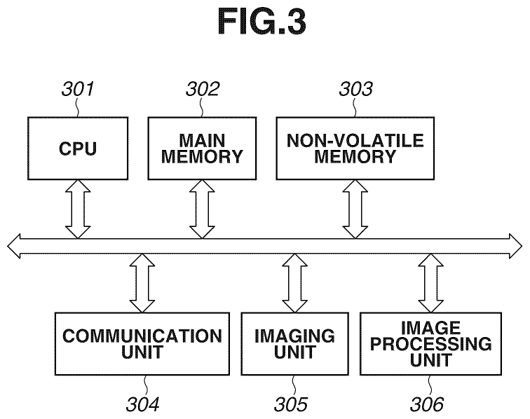

FIG. 3 is a block diagram illustrating an example of a hardware configuration of the imaging apparatus 102. The imaging apparatus 102 includes the following components.

A CPU 301 is a central processing unit configured to execute a program recorded in a non-volatile memory 303 and realize various processes described below. Specifically, it controls video acquisition, fingering analysis, and communication processing.

The non-volatile memory 303 is an electrically erasable and recordable memory (e.g., flash-ROM) and stores a program and a constant number necessary for the operation of the CPU 301. In the present exemplary embodiment, a computer program for executing various flowcharts described below is stored.

A main memory 302 uses, for example, a RAM, and constant and variable numbers necessary for the operation of the CPU 301 and a program read from the non-volatile memory 303 are loaded into the main memory 302.

A communication unit 304 connects to the image display apparatus 101 and the Internet using a communication unit, such as a wireless LAN or Bluetooth®, and transmits and receives a video signal, an audio signal, and a control signal. The communication unit 304 is capable of transmitting an image (including a live-view image) captured by an imaging unit 305 and receiving an image and information from an external device.

The imaging unit 305 is an image sensor configured to convert an optical image into an electrical signal and is composed of a CCD or CMOS sensor. The fingering of the musical instrument player or the instructor is captured, and the captured video is transmitted to an image processing unit 306. By acquiring high-resolution video, detailed fingering can be analyzed.

The image processing unit 306 performs predetermined image processing, such as pixel interpolation, resizing, and color conversion, on the image data acquired from the imaging unit 305. Further, predetermined computation processing is performed using the image data. The CPU 301 performs exposure control and ranging control based on the computation results from the image processing unit 306, and AF processing and AE processing are performed. This makes it possible to acquire an optimal video at all times.

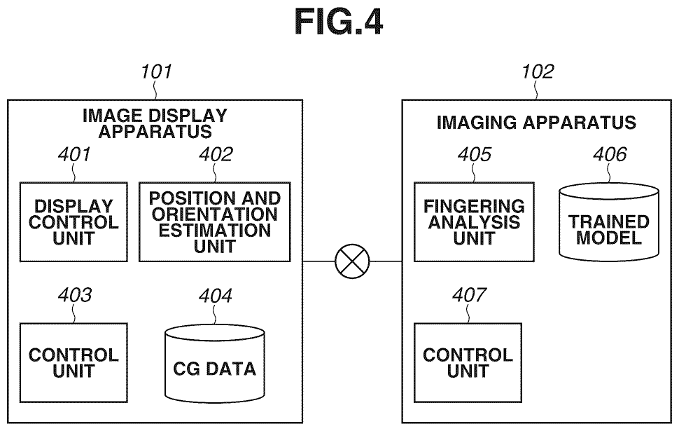

FIG. 4 is a block diagram illustrating a functional configuration of the system according to the first exemplary embodiment. A functional relationship between the image display apparatus 101 and the imaging apparatus 102 is illustrated.

Each function of the image display apparatus 101 is realized by the CPU 201, and the image display apparatus 101 includes a display control unit 401, a position and orientation estimation unit 402, and a control unit 403. Further, computer graphics (CG) data 404 is stored.

The display control unit 401 controls the content displayed on the display unit 204 based on an instruction from the control unit 403. Specifically, hand CGs are displayed at appropriate positions based on line-of-sight information about the user and acquired CG data.

The position and orientation estimation unit 402 estimates the three-dimensional positional relationship between the image display apparatus 101 and the keyboard instrument used by the user and their orientations based on the video acquired from the imaging unit 207 or the image processing unit 208. This makes it possible to display the hand CGs at correct positions.

The control unit 403 comprehensively controls the image display apparatus 101 and manages various types of processing and data.

The CG data 404 stores CG data generated by the control unit 403 based on the analysis result received from the imaging apparatus 102. This data is displayed on the display unit 204 by the display control unit 401.

Each function of the imaging apparatus 102 is realized by the CPU 301, and the imaging apparatus 102 includes a fingering analysis unit 405 and a control unit 407. Further, a trained model 406 is stored.

The fingering analysis unit 405 analyzes and estimates the fingering of the keyboard instrument player from the video acquired from the imaging unit 305 or the image processing unit 306 using the trained model 406. This makes it possible to digitize the precise fingering of the musical instrument player.

The trained model 406 is a model used by the fingering analysis unit 405 to estimate the fingering of the keyboard instrument player from the video and includes data that has been pre-trained using machine learning or deep learning. This enables high-precision analysis.

The control unit 407 comprehensively controls the imaging apparatus 102 and manages various types of processing and data.

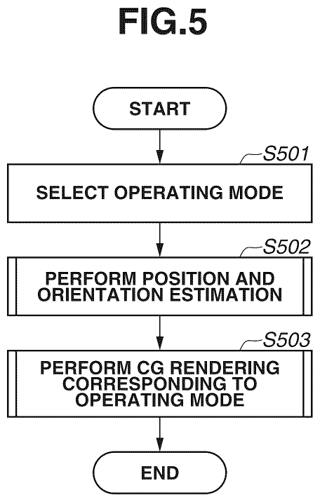

A process according to the first exemplary embodiment will be described in detail with reference to FIGS. 5 to 12. In the image display apparatus 101, a program recorded in the non-volatile memory 203 is loaded into the main memory 202 and executed by the CPU 201, thereby realizing the process. Similarly, the CPU 301 loads a program recorded in the non-volatile memory 303 into the main memory 302 and executes the loaded program to realize the process in the imaging apparatus 102.

FIG. 5 is a flowchart illustrating a procedure of the image display apparatus 101 according to the first exemplary embodiment.

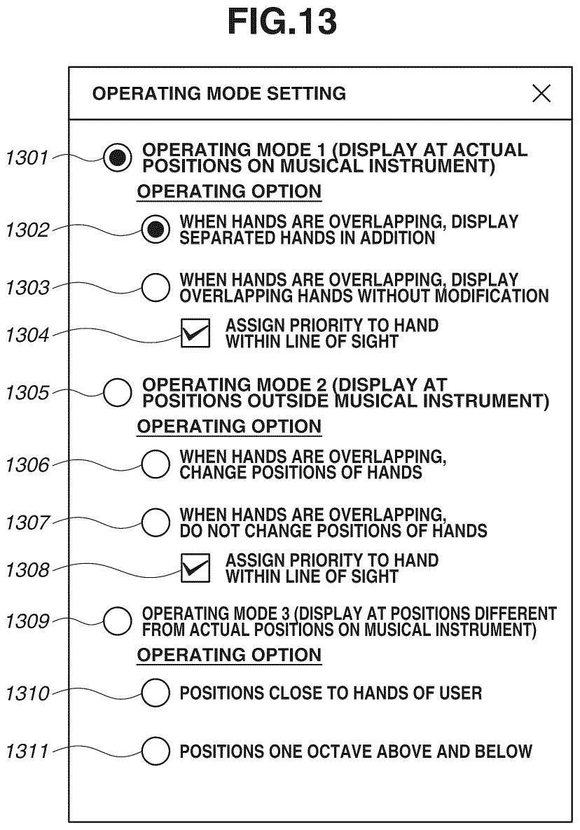

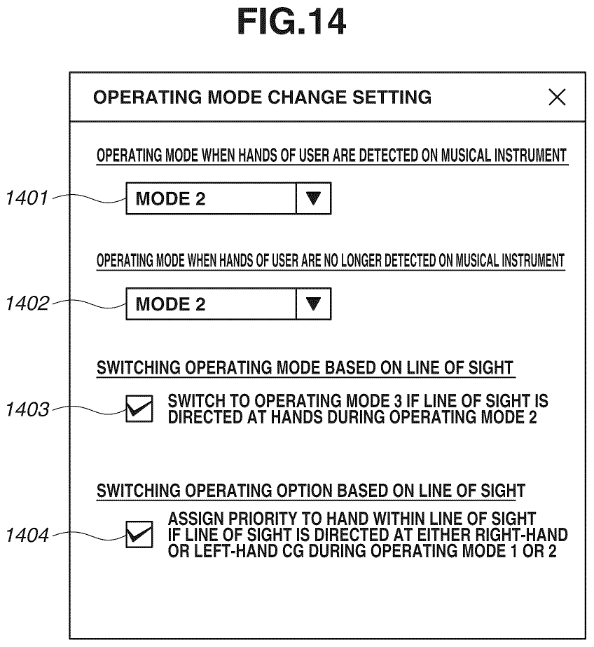

In step S501, the CPU 201 issues an instruction to display an operating mode setting screen, receives operating mode and option settings from the user, and stores the operating mode and option settings in the main memory 202. FIG. 13 illustrates an example of the operating mode setting screen. The user can select and set a plurality of operating modes and options on the screen. Further, a condition under which the system automatically switches the operating mode or option can be set on a screen illustrated in FIG. 14, and the operating mode can be configured to switch automatically in a case where a specific condition is met.

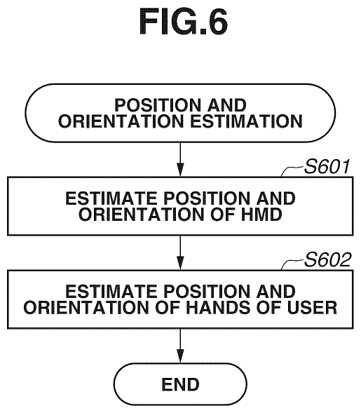

In step S502, the CPU 201 performs a position and orientation estimation process. Details of the position and orientation estimation process will be described below with reference to FIG. 6.

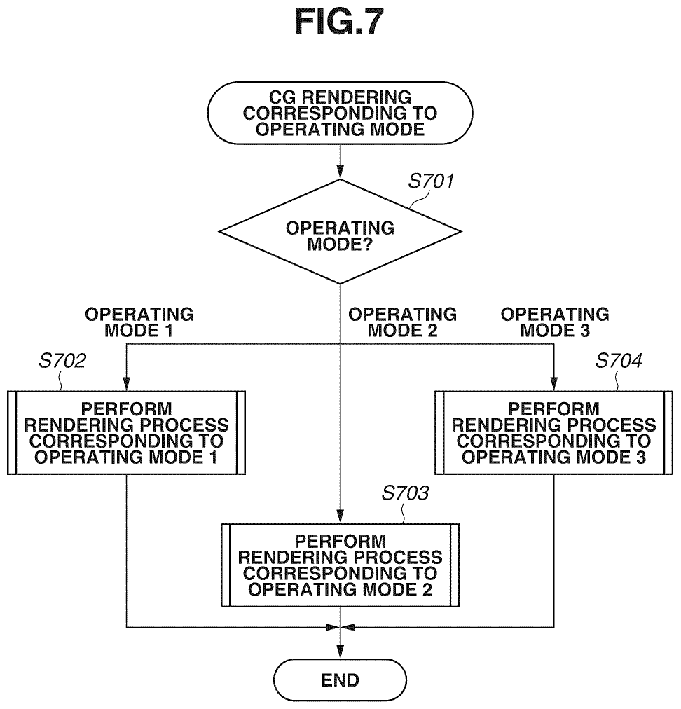

In step S503, the CPU 201 performs a CG rendering process corresponding to the set operating mode. Details of the CG rendering process corresponding to the operating mode will be described below with reference to FIG. 7.

FIG. 6 is a flowchart illustrating the position and orientation estimation process in the image display apparatus 101. Details of the position and orientation estimation process in step S502 in FIG. 5 will be described with reference to FIG. 6.

In step S601, the CPU 201 analyzes the video acquired from the imaging unit 207 and the image processing unit 208, estimates the positional relationship between the image display apparatus 101 and the keyboard instrument used by the user and their orientations, and stores the results in the main memory 202. Specifically, since the keyboard instrument has a repeating pattern of keys, this characteristic is used to estimate positions and angles. For example, by temporarily moving the image display apparatus 101 to a position where the entire keyboard is visible, the keyboard layout is recognized, and the relative position and orientation of the image display apparatus 101 with respect to the keyboard instrument are calculated. This position and orientation information is necessary to display hand CGs at correct position.

In step S602, the CPU 201 analyzes the video acquired from the imaging unit 207 and the image processing unit 208, and in a case where the hands of the user are on the keyboard instrument, the CPU 201 estimates the positions and orientations of the hands. The position and orientation information about the hands of the user is necessary to display the hand CGs without overlapping with the hands of the user.

FIG. 7 is a flowchart illustrating the CG rendering process corresponding to the operating mode in the image display apparatus 101. Details of the CG rendering process in step S503 in FIG. 5 will be described with reference to FIG. 7.

In step S701, the CPU 201 refers to the operating mode setting stored in the main memory 202 in step S501 and determines the process to be performed next.

In the case of an operating mode 1, the processing proceeds to step S702.

In the case of an operating mode 2, the processing proceeds to step S703.

In the case of an operating mode 3, the processing proceeds to step S704.

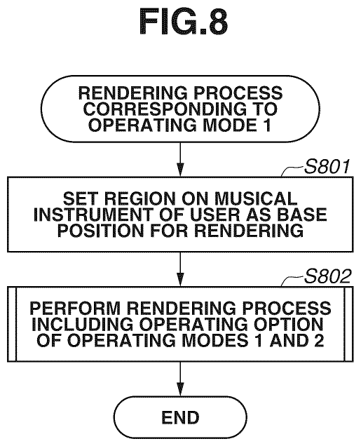

In step S702, the CPU 201 performs the rendering process corresponding to the operating mode 1. In the operating mode 1, the hand CGs are displayed at the actual positions on the musical instrument. This enables the user to view the reference hand movements directly on the musical instrument of the user. Details of the rendering process corresponding to the operating mode 1 will be described below with reference to FIG. 8.

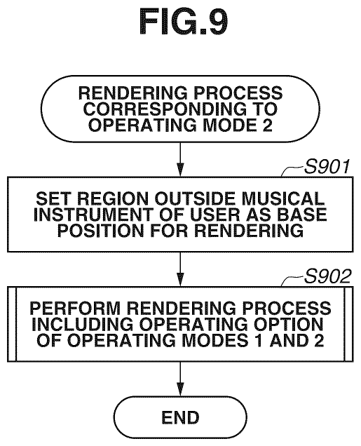

In step S703, the CPU 201 performs the rendering process corresponding to the operating mode 2. In the operating mode 2, hand CGs are displayed at positions outside the musical instrument. This enables the user to view the hands of the user and the reference hand movements simultaneously. Details of the rendering process corresponding to the operating mode 2 will be described below with reference to FIG. 9.

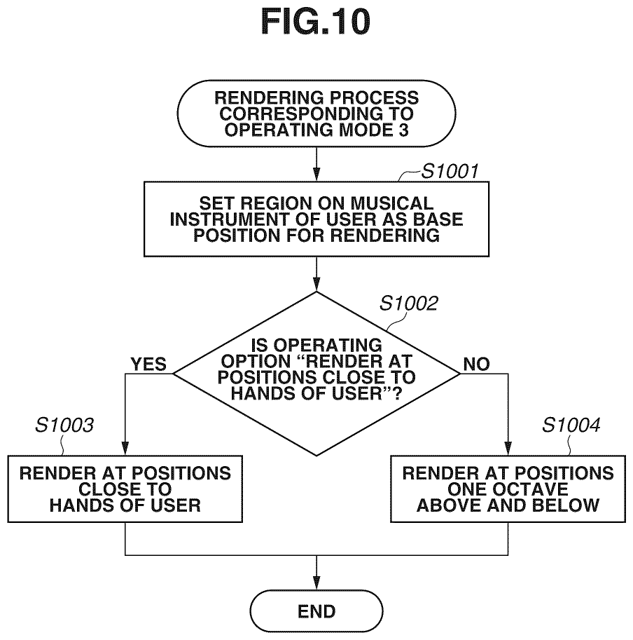

In step S704, the CPU 201 performs the rendering process corresponding to the operating mode 3. In the operating mode 3, hand CGs are displayed at positions where the hand CGs do not overlap with the hands of the user on the musical instrument. For example, displaying the reference hand CGs near the hands of the user can provide a clearer instruction. Details of the rendering process corresponding to the operating mode 3 will be described below with reference to FIG. 10.

FIG. 8 is a flowchart illustrating the rendering process corresponding to the operating mode 1 in the image display apparatus 101. Details of the rendering process corresponding to the operating mode 1 in step S702 in FIG. 7 will be described with reference to FIG. 8.

In step S801, the CPU 201 sets a region on the musical instrument used by the user as a base position for CG rendering and stores it in the main memory 202. This establishes a basis for displaying the hand CGs at the actual positions on the musical instrument.

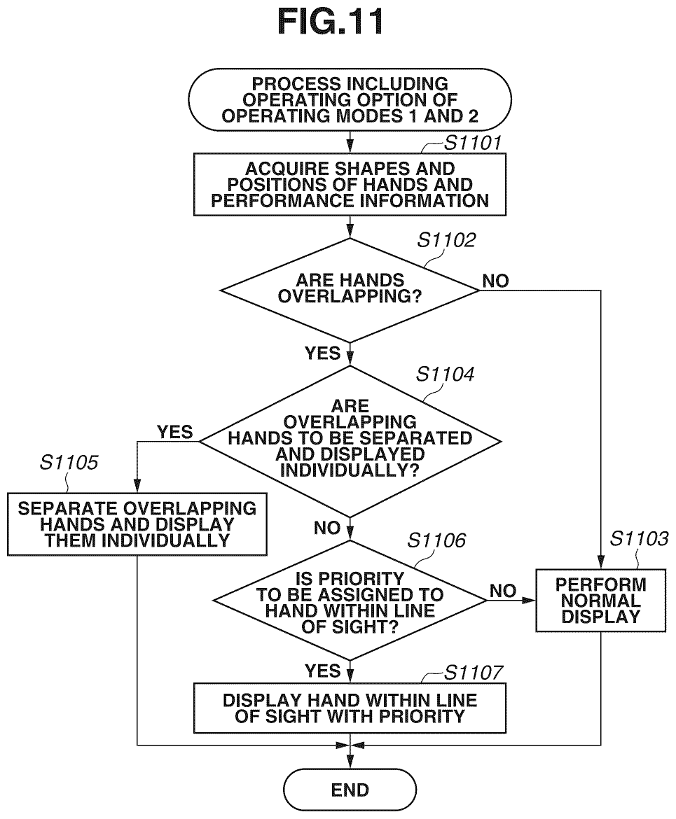

In step S802, the CPU 201 performs the rendering process considering the operating option applied to the operating modes 1 and 2. Specifically, a hand CG display method is adjusted based on the option set by the user. Details of the rendering process including the operating option will be described below with reference to FIG. 11.

FIG. 9 is a flowchart illustrating the rendering process corresponding to the operating mode 2 in the image display apparatus 101. Details of the rendering process corresponding to the operating mode 2 in step S703 in FIG. 7 will be described with reference to FIG. 9.

In step S901, the CPU 201 sets a region outside the musical instrument used by the user as a base position for CG rendering and stores it in the main memory 202. This establishes a basis for displaying hand CGs at positions outside the musical instrument.

In step S902, the CPU 201 performs the rendering process considering the operating option applied to the operating modes 1 and 2. The hand CG display method is adjusted based on the option set by the user. Details of the rendering process including the operating option will be described below with reference to FIG. 11.

FIG. 10 is a flowchart illustrating the rendering process corresponding to the operating mode 3 in the image display apparatus 101. Details of the rendering process corresponding to the operating mode 3 in step S704 in FIG. 7 will be described with reference to FIG. 10.

In step S1001, the CPU 201 sets a region on the musical instrument used by the user as a base position for CG rendering and stores it in the main memory 202. This establishes a basis for displaying hand CGs at appropriate positions on the musical instrument.

In step S1002, the CPU 201 refers to the operating option setting stored in the main memory 202 in step S501 and determines the process to be performed next.

In a case where the operating option is “render at positions close to the hands of the user”, the processing proceeds to step S1003.

In a case where the operating option is “render at positions one octave above and below”, the processing proceeds to step S1004.

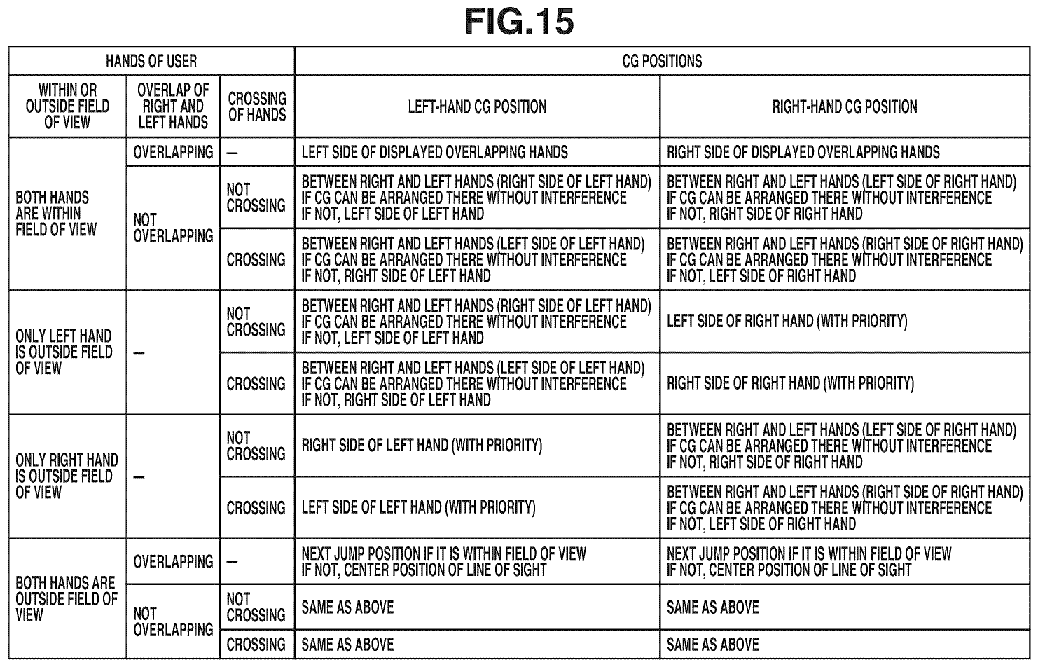

In step S1003, the CPU 201 performs control for CG rendering at positions close to the hands of the user. The positions of the hands of the user on the musical instrument, the position of the line of sight of the user, and the field of view of the user are considered, and the hands CG are arranged at appropriate positions. FIG. 15 illustrates an example of the control for CG rendering at positions close to the hands of the user. Details of the control for CG rendering at positions close to the hands of the user will be described with reference to FIGS. 15 and 16 to 23.

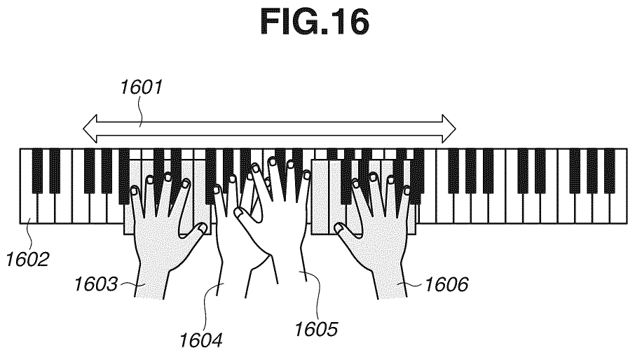

FIG. 16 illustrates a display example corresponding to the first row in FIG. 15. Both the right and left hands of the user are within a field of view, and the right and left hands are overlapping. In this case, a left hand CG 1603 is arranged on the left side of a left hand 1604 of the user, and a right hand CG 1606 is arranged on the right side of a right hand 1605 of the user.

However, the hand CGs alone do not provide sufficient understanding because of their deviations from the actual sound position. Thus, a keyboard CG is also generated and rendered together with the hand CG. The keyboard CG renders the keys from a half step below the lowest note pressed by the user to a half step above the highest note. In the descriptions of FIGS. 10 and 11, hand and keyboard CGs are generated similarly.

The hand and keyboard CGs are also arranged next to the hands of the user using one of the following methods.

The position of the key that is a half step below the lowest note pressed by a hand of the user is aligned with the position of the highest note portion of the keyboard CG.

The position of the key that is a half step above the highest note pressed by a hand of the user is aligned with the position of the lowest note portion of the keyboard CG.

Even in the following descriptions, hand and keyboard CGs will be rendered using a similar method when arranged next to the hands of the user.

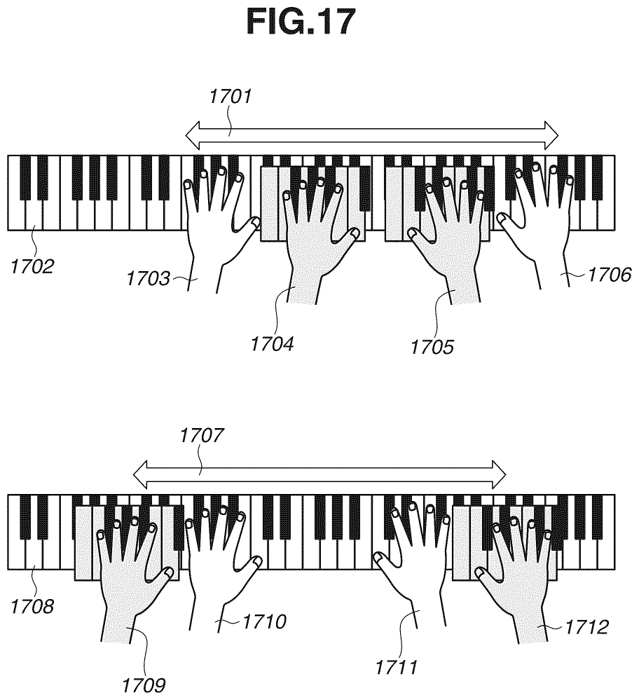

FIG. 17 illustrates a display example corresponding to the second row in FIG. 15. Both the right and left hands of the user are within a field of view, and the right and left hands are neither overlapping nor crossing. In this case, a left hand CG 1704 is arranged on the right side of a left hand 1703 of the user, and a right hand CG 1705 is arranged on the left side of a right hand 1706 of the user.

However, in a case where the right CG and the left CG interfere with each other, the arrangement is adjusted as follows.

A left hand CG 1709 is arranged on the left side of a left hand 1710 of the user.

A right hand CG 1712 is arranged on the right side of a right hand 1711 of the user.

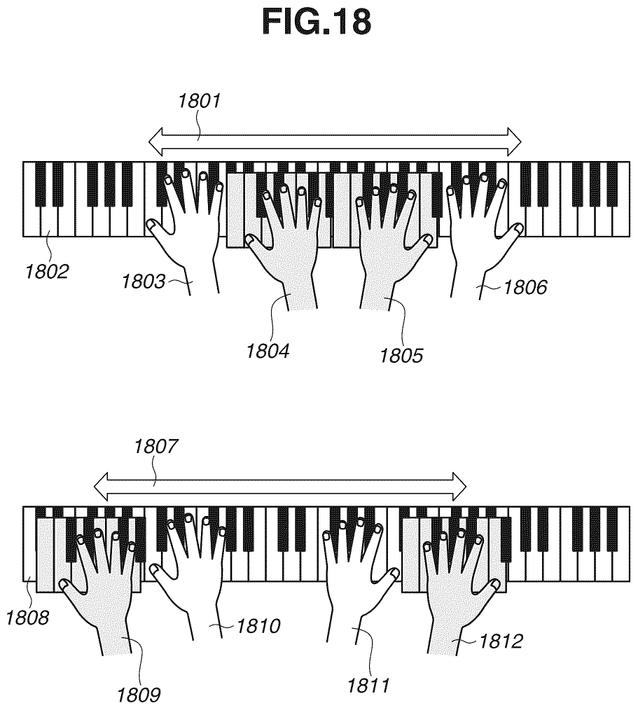

FIG. 18 illustrates a display example corresponding to the third row in FIG. 15. Both the right and left hands of the user are within a field of view, and the right and left hands are crossing but not overlapping. In this case, a left hand CG 1805 is arranged on the left side of a left hand 1806 of the user, and a right hand CG 1804 is arranged on the right side of a right hand 1803 of the user.

However, in a case where the right CG and the left CG interfere with each other, the arrangement is adjusted as follows.

A left hand CG 1812 is arranged on the right side of a left hand 1811 of the user.

A right hand CG 1809 is arranged on the left side of a right hand 1810 of the user.

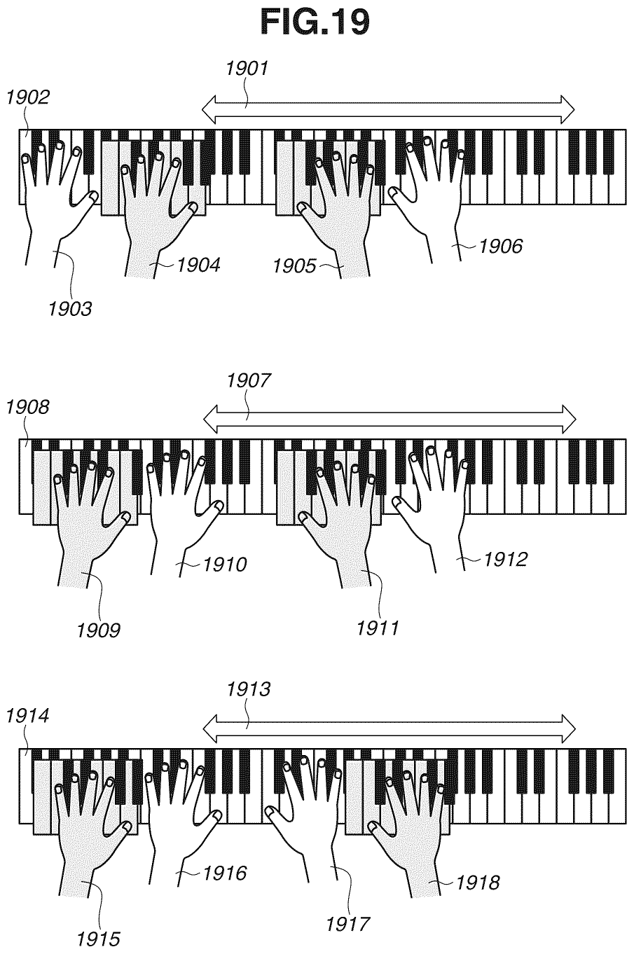

FIG. 19 illustrates a display example corresponding to the fourth row in FIG. 15. The left hand of the user is outside the field of view, and the right hand is within a field of view. The right and left hands are not crossing. In this case, a left hand CG 1904 is arranged on the right side of a left hand 1903 of the user, and a right hand CG 1905 is arranged on the left side of a right hand 1906 of the user.

However, in a case where the right CG and the left CG interfere with each other, priority is assigned to the right hand CG position, and the arrangement is as follows.

A left hand CG 1909 is arranged on the left side of a left hand 1910 of the user.

A right hand CG 1911 is arranged at the current position.

Furthermore, in a case where a right hand CG 1918 interferes with a left hand 1916 of the user, the arrangement is as follows.

A left hand CG 1915 is arranged on the left side of a left hand 1916 of the user.

A right hand CG 1918 is arranged on the right side of a right hand 1917 of the user.

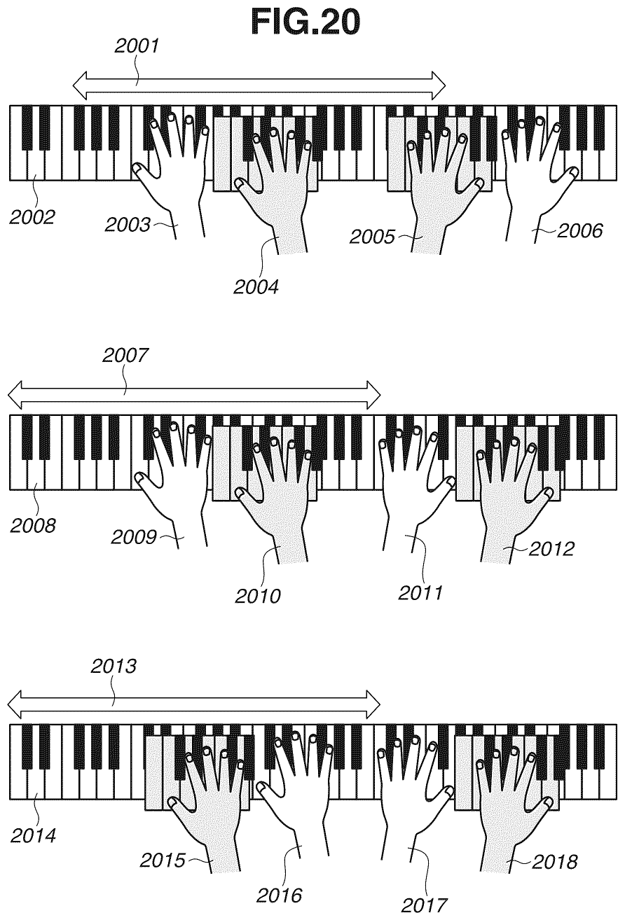

FIG. 20 illustrates a display example corresponding to the fifth row in FIG. 15. The left hand of the user is outside a field of view, and the right hand is within the field of view. The right and left hands are crossing. In this case, a left hand CG 2005 is arranged on the left side of a left hand 2006 of the user, and a right hand CG 2004 is arranged on the right side of a right hand 2003 of the user.

However, in a case where the right CG and the left CG interfere with each other, priority is assigned to the right hand CG position, and the arrangement is as follows.

A left hand CG 2012 is arranged on the right side of a left hand 2011 of the user.

A right hand CG 2010 is arranged at the current position.

Further, in a case where a right hand CG 2015 interferes with a left hand 2017 of the user, the arrangement is as follows.

A left hand CG 2018 is arranged on the right side of a left hand 2017 of the user.

A right hand CG 2015 is arranged on the left side of a right hand 2016 of the user.

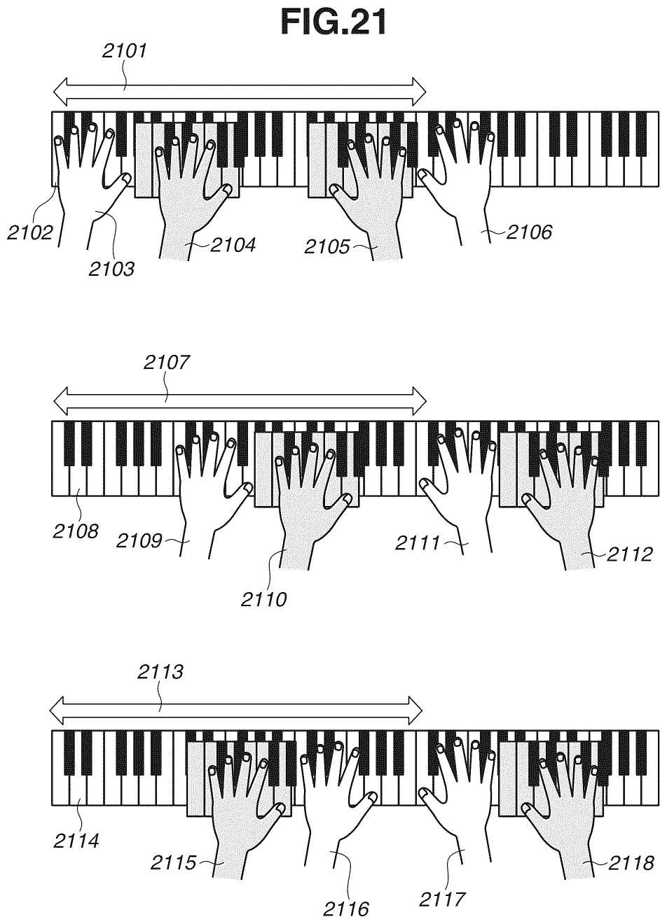

FIG. 21 illustrates a display example corresponding to the sixth row in FIG. 15. The left hand of the user is within a field of view, and the right hand is outside the field of view. The right and left hands are not crossing. In this case, a left hand CG 2104 is arranged on the right side of a left hand 2103 of the user, and a right hand CG 2105 is arranged on the left side a right hand 2106 of the user.

However, in a case where the right CG and the left CG interfere with each other, priority is assigned to the left hand CG position, and the arrangement is as follows.

A left hand CG 2110 is arranged at the current position.

A right hand CG 2112 is arranged on the right side of a right hand 2111 of the user.

Furthermore, in a case where a left hand CG 2115 interferes with a right hand 2117 of the user, and the arrangement is as follows.

The left hand CG 2115 is arranged on the left side of a left hand 2116 of the user.

A right hand CG 2118 is arranged on the right side of the right hand 2117 of the user.

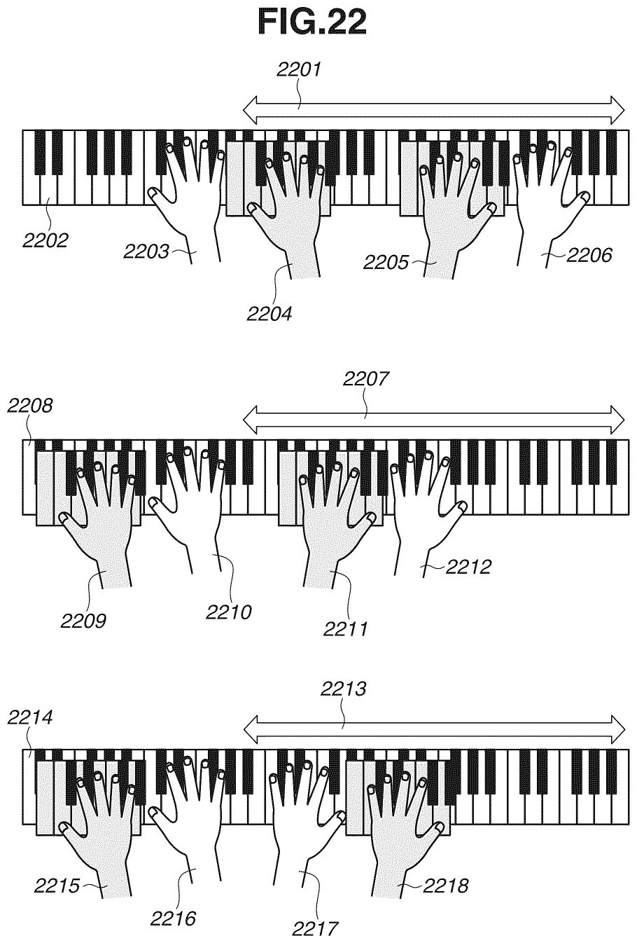

FIG. 22 illustrates a display example corresponding to the seventh row in FIG. 15. The left hand of the user is outside a field of view, and the right hand is within the field of view. The right and left hands are crossing. In this case, a left hand CG 2205 is arranged on the left side of a left hand 2206 of the user, and a right hand CG 2204 is arranged on the right side of a right hand 2203 of the user.

However, in a case where the right CG and the left CG interfere with each other, priority is assigned to the left hand CG position, and the arrangement is as follows.

A left hand CG 2211 is arranged at the current position.

A right hand CG 2209 is arranged on the left side of a right hand 2210 of the user.

Furthermore, in a case where a left hand CG 2218 interferes with a right hand 2216 of the user, the arrangement is as follows.

The left hand CG 2218 is arranged on the right side of a left hand 2217 of the user.

A right hand CG 2215 is arranged on the left side of the right hand 2216 of the user.

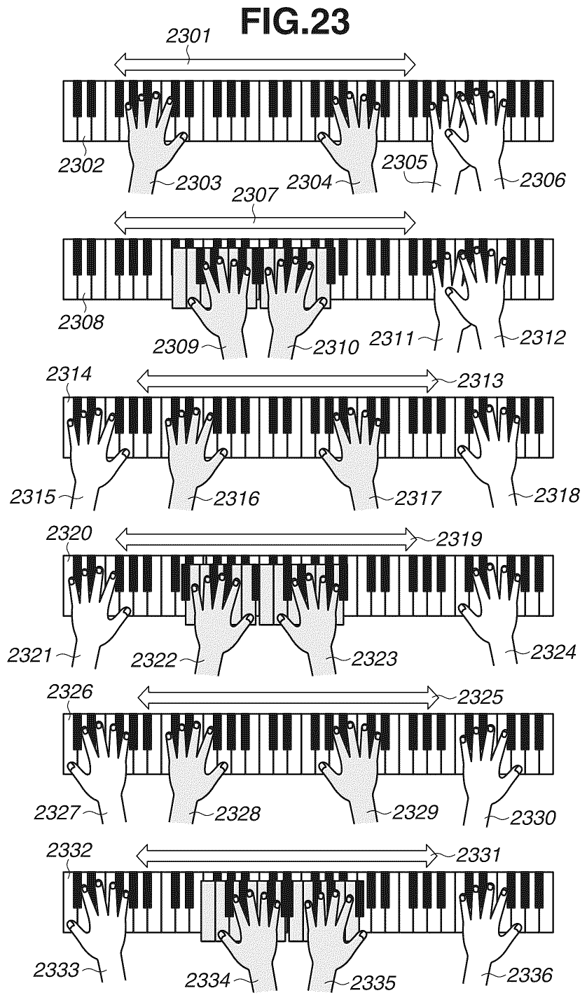

FIG. 23 illustrates a display example corresponding to the tenth row in FIG. 15.

The first example is a case where both hands of the user are outside a field of view and the right and left hands are overlapping. At this time, if the intended pitch and display position of the CG to be rendered next are within the field of view, a left hand CG 2303 and a right hand CG 2304 are arranged at that position. If not, a left hand CG 2310 and a right hand CG 2309 are arranged side by side at the keyboard position corresponding to the center of the line of sight of the user.

The second example is a case where both hands of the user are outside the field of view and the right and left hands are neither overlapping nor crossing. In this case, if the intended pitch and display position of the CG to be rendered next are within the field of view, a left hand CG 2316 and a right hand CG 2317 are arranged at that position, whereas if the intended pitch and display position are not within the field of view, a left hand CG 2322 and a right hand CG 2323 are arranged side by side at the keyboard position corresponding to the center of the line of sight of the user.

The third example is a case where both hands of the user are outside the field of view and the right and left hands are crossing but not overlapping. In this case, similarly, if the intended pitch and display position of the CG to be rendered next are within the field of view, a left hand CG 2328 and a right hand CG 2329 are arranged at that position. If not, a left hand CG 2335 and a right hand CG 2334 are arranged side by side at the keyboard position corresponding to the center of the line of sight of the user.

The phrase “CG to be rendered next” refers to a CG to be rendered within a specified period. Examples of the specified period include, but are not limited to, one second or one measure of a musical piece.

One specific example of FIG. 23 is a case where there is a large jump to the next pitch on the musical instrument. Control is performed so that the CG is displayed at the position of the next pitch when the user, conscious of the jump to the next pitch, shifts their gaze near the next pitch.

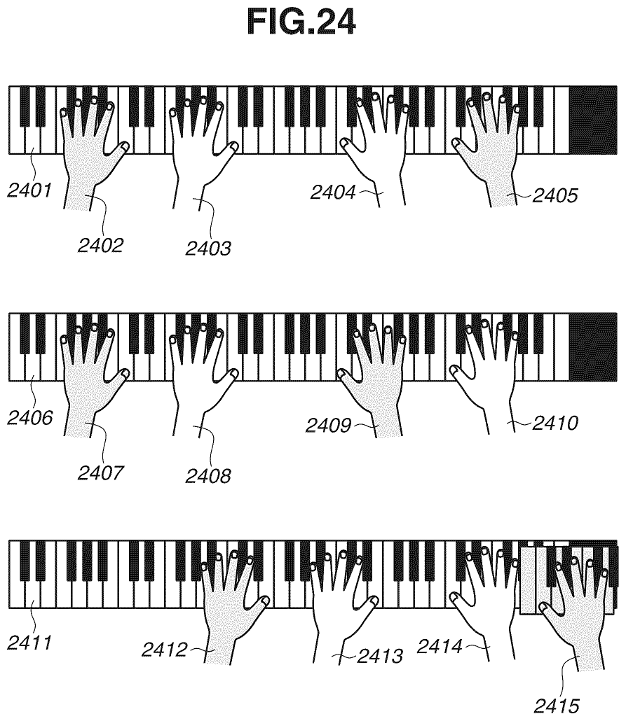

In step S1004, the CPU 201 performs control for CG rendering at positions one octave above and below. FIG. 24 illustrates a possible example of CG rendering at positions one octave above and below.

A right hand CG 2405 is arranged one octave above a right hand 2404 of the user, and a left hand CG 2402 is arranged one octave below a left hand 2403 of the user. However, in a case where a position one octave above the right hand or a position one octave below the left hand near the highest or lowest note on the keyboard does not fit on the musical instrument, a right hand CG 2409 is arranged one octave below a right hand 2410, and a left hand CG 2407 is arranged.

Furthermore, in a case where a right hand CG 2415 arranged one octave below a right hand 2414 interferes with a left hand 2413 of the user, the right hand CG 2415 is arranged near the right hand 2414 of the user, even if the right hand CG 2415 does not fit on the keyboard.

In this case, as in step S1003, the keyboard CG is arranged using the following method.

The highest pitch portion of the keyboard CG is arranged to overlap with the key one half step below the lowest note pressed by a hand of the user.

The lowest pitch portion of the keyboard CG is arranged to overlap with the key one half step above the highest note pressed by a hand of the user.

In a case where there is no key one half step below the lowest note or above the highest note on the musical instrument, the arrangement is made at the corresponding position based on the width of the keyboard.

While FIG. 24 illustrates an example for the right hand, the similar applies to the left hand, and control near the lowest note is performed symmetrically.

FIG. 11 is a flowchart illustrating a process including the operation option of the operating modes 1 and 2 of the image display apparatus 101 according to the first exemplary embodiment.

Details of the rendering process including the operating option of the operating modes 1 and 2 in step S802 in FIG. 8 and step S902 in FIG. 9 will be described with reference to FIG. 11.

In step S1101, the CPU 201 acquires the video and fingering estimation information received from the imaging apparatus 102 via the communication unit 206 and stored in the main memory 202.

In step S1102, the CPU 201 refers to the acquired fingering estimation information and determines whether the hands are overlapping. In a case where the hands are overlapping (YES in step S1102), the processing proceeds to step S1104. If not (NO in step S1102), the processing proceeds to step S1103.

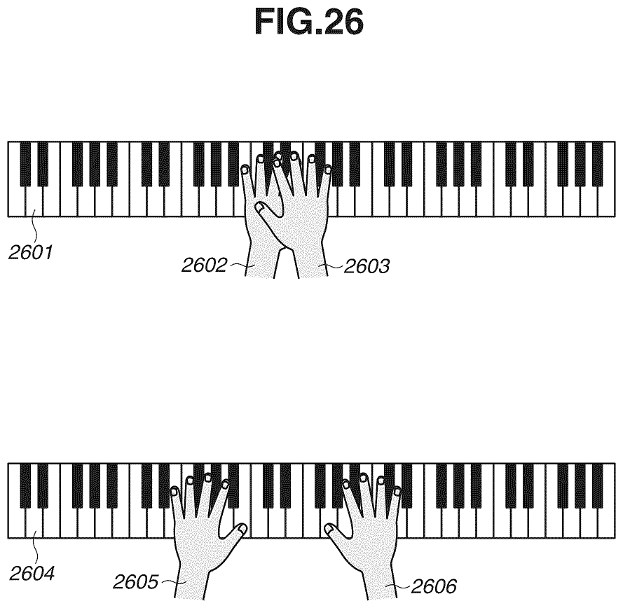

In step S1103, the CPU 201 performs normal display control. FIG. 26 illustrates a possible example of normal display.

First, the base position setting for rendering stored in the main memory 202 in step S801 or S901 is referred to. In a case where the base position setting for rendering is on the musical instrument of the user, the hand CGs (2602, 2603, 2605, 2606) are rendered on the actual musical instrument of the user. At this time, the positions of the hand CGs on the musical instrument is controlled by referring to the position and orientation estimation result acquired in step S601 and the hand position specified by the fingering estimation information so that the hand position specified by the fingering estimation information and the pitch on the actual musical instrument correspond to each other.

In contrast, in a case where the base position setting for rendering is outside the musical instrument of the user, the keyboard and hand CGs are rendered at positions at a predetermined distance from the musical instrument of the user. Examples of the distance include, but are not limited to, approximately 30 cm (centimeters). The positional relationship between the keyboard and hand CGs is similar to that on the musical instrument, and the hand position specified by the fingering estimation information and the pitch on the actual musical instrument are controlled to correspond to each other.

The keyboard and hand CGs may be rendered at any position outside the actual musical instrument. For example, the keyboard and hand CGs may be rendered 30 cm behind the musical instrument. However, this is not limited thereto.

The phrase “outside the musical instrument” refers to a state where the target is not present anywhere along a vertical direction in three-dimensional space. In such a case, the target is considered to be outside the musical instrument.

In step S1104, the CPU 201 refers to the operating option set in step S501 and determines whether to separate the overlapping hands and display the separated hands individually in a case where the hands are overlapping. In a case where it is determined to display them (YES in step S1104), the processing proceeds to step S1105. If not (NO in step S1104), the processing proceeds to step S1106.

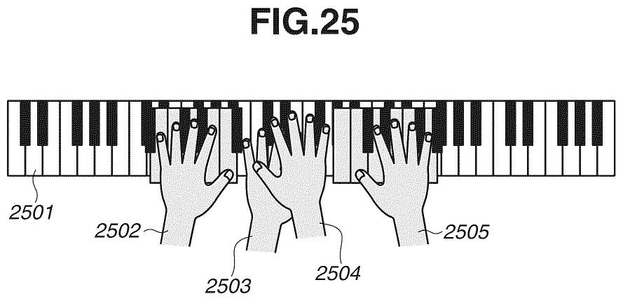

In step S1105, the CPU 201 performs normal display corresponding to step S1103 and further performs control to separate the right-hand CG and the left-hand CG and display them individually. FIG. 25 illustrates a possible example of displaying the separated right-hand and left-hand CGs individually.

First, the fingering estimation information is referred to, and the positions of the overlapping right and left hands, the pitches of the pressed keys, and the shapes of the hands are acquired. Then, the overlapping hands are separated, and the right-hand CG and the left-hand CG are generated and arranged on the actual keyboard of the user individually. The CG for each hand is generated using a similar processing as in step S1003.

Regarding the CG arrangement, a left hand CG 2502 is arranged such that the highest pitch portion of the keyboard of the left hand CG 2502 overlaps with the key one half step below the lowest note pressed by one of the overlapping right and left hands. A right hand CG 2505 is arranged such that the lowest pitch portion of the keyboard of the right hand CG 2505 overlaps with the key one half step above the highest note being pressed.

In step S1106, the CPU 201 refers to the operating option set in step S501 and determines whether to assign priority to the hand within the line of sight. In a case where priority is to be assigned (YES in step S1106), the processing proceeds to step S1107. If not (NO in step S1106), the processing proceeds to step S1108.

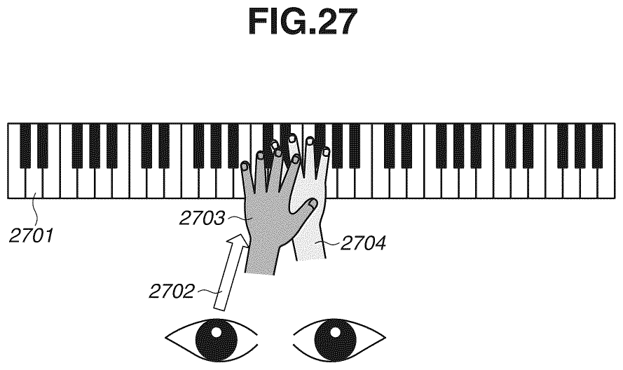

In step S1107, the CPU 201 performs normal display corresponding to step S1103 and further performs control to display the hand within the line of sight with priority. FIG. 27 illustrates a possible example of displaying the hand within the line of sight with priority.

Specifically, the line of sight of the user detected by the line-of-sight detection unit 205 is acquired, and it is determined whether the normally displayed CG and a line of sight 2702 of the user intersect. In a case where the line of sight 2702 intersects, it is determined which of the right or left CG intersects with the line of sight 2702, and the corresponding hand (hand CG 2703) is highlighted and displayed.

To highlight and display, the color and transparency of the hand CG that intersects with the line of sight are changed to make it more prominent than the other hand. Alternatively, the color and transparency of the hand CG that does not intersect with the line of sight may be changed to make it less prominent than the hand that intersects with the line of sight. These are merely examples of highlighting and are not intended to be limitations.

Furthermore, since sound is also an important element in instrumental performance, acoustic effects are controlled in coordination with the highlighting of the hand that intersects with the line of sight, further emphasizing the hand that intersects with the line of sight. Possible examples of acoustic effects include, but are not limited to, controlling the sound played by the hand that intersects with the line of sight to make it louder than the sound played by the other hand.

In the control described above, there are various methods for addressing the situation where the line of sight of the user intersects with the hand CG. Possible examples include a method of immediately applying the control described above to either the left or right CG and a method of measuring the accumulated gaze time within a predetermined period to determine which CG to apply the control to. These are merely examples of processing application methods and are not intended to be limitations.

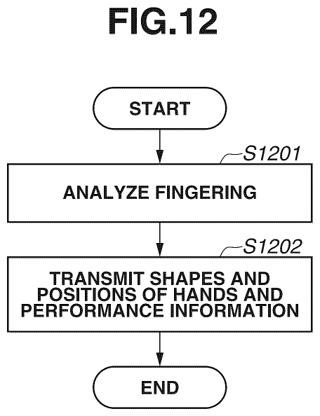

FIG. 12 is a flowchart illustrating a procedure of the imaging apparatus 102 according to the first exemplary embodiment.

In step S1201, the CPU 301 analyzes the video acquired from the imaging unit 305 and the image processing unit 306 using the trained model 406, estimates the shapes (fingering) and positions of the hands of the musical instrument player in the video, and stores the results in the main memory 302.

In step S1202, the CPU 301 transmits the shapes and positions of the hands and performance information stored in the main memory 302 to the image display apparatus 101 via the communication unit 304.

FIG. 13 illustrates a display example of the operating mode setting screen in the flowchart in FIG. 5. The numerical values 1301, 1305, and 1309 represent operating modes that can be selected in the first exemplary embodiment, and one of the plurality of operating modes can be selected. Operating options 1302 to 1304, 1306 to 1308, or 1310 and 1311 can be set for the selected operating mode. The user can configure these setting items as desired.

The operating mode 1301 represents the operating mode 1. Either the option 1302 or 1303 can be set for this operating mode.

The option 1302 is one of the options for the operating mode 1 and indicates “when the hands are overlapping, display separated hands in addition”.

The option 1303 is another one of the options for the operating mode 1 and indicates “when the hands are overlapping, display the overlapping hands without modification”, and the option 1304 can be set as an advanced option setting.

The option 1304 is an advanced item for “when the hands are overlapping, display the overlapping hands without modification”, and the setting “assign priority to the hand within the line of sight” can be enabled or disabled using a checkbox.

The operating mode 1305 represents the operating mode 2. Either the option 1306 or 1307 can be set for this operating mode.

The option 1306 is one of the options for the operating mode 2 and indicates “when the hands are overlapping, display separated hands in addition”.

The option 1307 is another one of the options for the operating mode 2 and indicates “when the hands are overlapping, display the overlapping hands without modification”, and the option 1308 can be set as an advanced option setting.

The option 1308 is an advanced item for “when the hands are overlapping, display the overlapping hands without modification”, and the setting “assign priority to the hand within the line of sight” can be enabled or disabled using a checkbox.

The operating mode 1309 represents the operating mode 3. Either the option 1310 or 1311 can be set for this operating mode.

The option 1310 is one of the options for the operating mode 3 and indicates displaying at “positions close to the hands of the user”.

The option 1311 is another one of the options for the operating mode 3 and indicates displaying at “positions one octave above and below”.

FIG. 14 illustrates a display example of an operating mode setting change screen for configuring a condition under which the system automatically switches the operating mode and the operating option in the flowchart in FIG. 5.

A setting 1401 represents an operating mode applied when the hands of the user are detected on the musical instrument, and can be selected from prepared options (mode 1 to mode 3). This setting is applied to automatically switch to the selected operating mode in a case where there is a change from a state where the hands of the user are absent on the musical instrument to a state where the hands of the user are present on the musical instrument.

A setting 1402 represents an operating mode applied when the hands of the user are no longer detected on the musical instrument, and can be selected from prepared options (mode 1, mode 2). This setting is applied to automatically switch to the selected operating mode in a case where there is a change from the state where the hands of the user are present on the musical instrument to the state where the hands of the user are absent on the musical instrument.

A setting 1403 represents a setting for switching the operating mode based on the line of sight, and the setting “switch to the operating mode 3 if the line of sight is directed at the hands during the operating mode 2” can be enabled or disabled using a checkbox. In a case where this setting is enabled and the operating mode 2 is being applied, if the line of sight of the user is directed at the hands on the actual musical instrument, the setting is applied to automatically switch to the operating mode 3. A possible criterion for determining that the line of sight is directed at the hands may be a case where the total time during which the line of sight points to a position on the musical instrument is 15 seconds or more within the most recent 30 seconds. However, this is merely one example and is not intended to be a limitation.

A setting 1404 represents a setting for switching the operating option based on the line of sight, and the setting “assign priority to the hand within the line of sight if the line of sight is directed at either the right-hand or left-hand CG during the operating mode 1 or 2” can be enabled or disabled using a checkbox. In a case where this setting is enabled and the operating mode 1 or 2 is being applied, if the line of sight is directed at either the right or left CG, the setting is applied, and the hand within the line of sight is displayed with priority.

A possible criterion for determining that the line of sight is directed at either the right or left CG may be a case where the total time during which the line of sight points to either the right or left CG is 15 seconds or more within the most recent 30 seconds. However, this is merely one example and is not intended to be a limitation.

FIG. 15 is a table presenting details of the control for CG rendering at positions close to the hands of the user in the flowchart in FIG. 10. There are conditions such as “within or outside the field of view”, “overlap of right and left hands”, and “crossing of hands” for the hands of the user, and each row describes the positions for arranging the left-hand CG and the right-hand CG based on the conditions.

FIG. 16 illustrates a display example corresponding to the first row in FIG. 15. A field of view 1601 represents an extent of the field of view of the user. A keyboard 1602 represents the actual keyboard played by the user. The CGs 1603 and 1606 represent hand and keyboard CGs. The hands 1604 and 1605 represent the actual hands of the user.

FIG. 17 illustrates a display example corresponding to the second row in FIG. 15. Fields of view 1701 and 1707 each represent an extent of the field of view of the user. Keyboards 1702 and 1708 each represent the actual keyboard played by the user. CGs 1704, 1705, 1709, and 1712 represent hand and keyboard CGs. Hands 1703, 1706, 1710, and 1711 represent the actual hands of the user.

FIG. 18 illustrates a display example corresponding to the third row in FIG. 15. Fields of view 1801 and 1807 each represent an extent of the field of view of the user. Keyboards 1802 and 1808 each represent the actual keyboard played by the user. CGs 1804, 1805, 1809, and 1812 represent hand and keyboard CGs. Hands 1803, 1806, 1810, and 1811 represent the actual hands of the user.

FIG. 19 illustrates a display example corresponding to the fourth row in FIG. 15. Fields of view 1901, 1907, and 1913 each represent an extent of the field of view of the user. Keyboards 1902, 1908, and 1914 each represent the actual keyboard played by the user. CGs 1904, 1905, 1909, 1911, 1915, and 1918 represent hand and keyboard CGs. Hands 1903, 1906, 1910, 1912, 1916, and 1917 represent the actual hands of the user.

FIG. 20 illustrates a display example corresponding to the fifth row in FIG. 15. Fields of view 2001, 2007, and 2013 each represent an extent of the field of view of the user. Keyboards 2002, 2008, and 2014 each represent the actual keyboard played by the user. CGs 2004, 2005, 2010, 2012, 2015, and 2018 represent hand and keyboard CGs. Hands 2003, 2006, 2009, 2011, 2016, and 2017 represent the actual hands of the user.

FIG. 21 illustrates a display example corresponding to the sixth row in FIG. 15. Fields of view 2101, 2107, and 2113 each represent an extent of the field of view of the user. Keyboards 2102, 2108, and 2114 each represent the actual keyboard played by the user. CGs 2104, 2105, 2110, 2112, 2115, and 2118 represent hand and keyboard CGs. Hands 2103, 2106, 2109, 2111, 2116, and 2117 represent the actual hands of the user.

FIG. 22 illustrates a display example corresponding to the seventh row in FIG. 15. Fields of view 2201, 2207, and 2213 each represent an extent of the field of view of the user. Keyboards 2202, 2208, and 2214 each represent the actual keyboard played by the user. CGs 2204, 2205, 2209, 2211, 2215, and 2218 represent hand and keyboard CGs. Hands 2203, 2206, 2210, 2212, 2216, and 2217 represent the actual hands of the user.

FIG. 23 illustrates display examples corresponding to the eighth to tenth rows in FIG. 15. Fields of view 2301, 2307, 2313, 2319, 2325, and 2331 each represent an extent of the field of view of the user. Keyboards 2302, 2308, 2314, 2320, 2326, and 2332 each represent the actual keyboard played by the user. CGs 2303, 2304, 2309, 2310, 2316, 2317, 2322, 2323, 2328, 2329, 2334, and 2335 represent hand and keyboard CGs. Hands 2305, 2306, 2311, 2312, 2315, 2318, 2321, 2324, 2327, 2330, 2333, and 2336 represent the actual hands of the user.

FIG. 24 illustrates display examples in a case where control is performed to render at positions one octave above and below in the flowchart in FIG. 10. Keyboards 2401, 2406, and 2411 each represent the actual keyboard played by the user. CGs 2402, 2405, 2407, 2409, 2412, and 2415 represent hand and keyboard CGs. Hands 2403, 2404, 2408, 2410, 2413, and 2414 represent the actual hands of the user.

FIG. 25 illustrates a display example in a case where control is performed to separate overlapping hands and display the separated hands individually. A keyboard 2501 represents the actual keyboard played by the user. CGs 2502 and 2505 represent hand and keyboard CGs after the overlapping hands are separated. CGs 2503 and 2504 represent unseparated overlapping hand CGs at their original positions.

FIG. 26 illustrates display examples in a case where normal display is performed in the flowchart in FIG. 11. A keyboard 2601 represents the actual keyboard played by the user. CGs 2602 to 2606 represent hand CGs.

FIG. 27 illustrates a display example in a case where control is performed to display the hand within the line of sight with priority in the flowchart in FIG. 11. A keyboard 2701 represents the actual keyboard played by the user. The line of sight 2702 represents the line of sight of the user. The hand CG 2703 represents a CG for the hand (left hand) within the line of sight of the user. A hand CG 2704 represents a CG for the hand (right hand) that is not within the line of sight of the user.

A second exemplary embodiment of the present disclosure will be described with reference to the drawings. A difference from the first exemplary embodiment will mainly be described. In the drawings of the second exemplary embodiment, the same reference numerals are assigned to the parts that are similar to those in the first exemplary embodiment, and a detailed description is omitted.

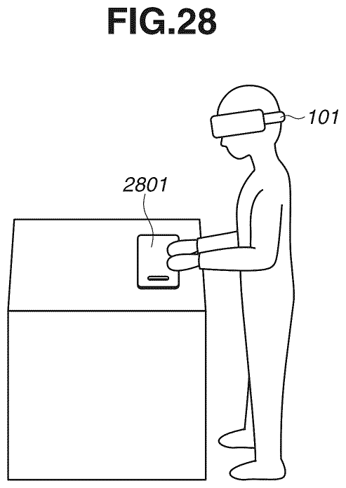

FIG. 28 is a schematic diagram illustrating one example of a system configuration according to the second exemplary embodiment. The system consists of the image display apparatus 101 alone.

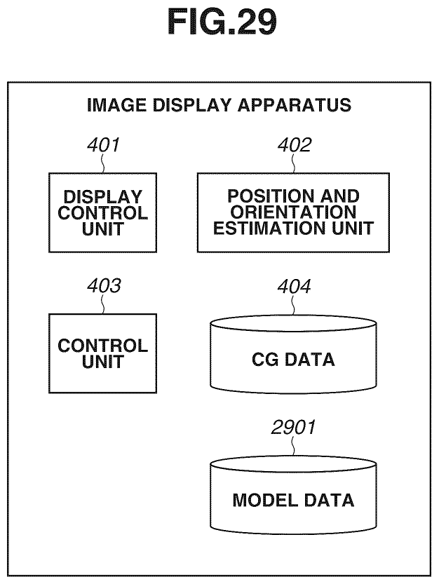

FIG. 29 is a diagram illustrating a functional configuration of the system according to the second exemplary embodiment.

Each function of the image display apparatus 101 is realized by the CPU 201. The image display apparatus 101 includes the display control unit 401, the position and orientation estimation unit 402, the control unit 403, the CG data 404, and model data 2901.

The position and orientation estimation unit 402 estimates the three-dimensional positions and orientations of the image display apparatus 101 and a cooking tool used by the user based on the video acquired from the imaging unit 207 and the image processing unit 208.

The CG data 404 stores data for CG display generated by the control unit 403 by performing a process described below on the model data 2901.

The model data 2901 corresponds to the analysis result received from the imaging apparatus 102, and the control unit 403 performs the process described below on the model data 2901 to store the data for CG display.

A process according to the second exemplary embodiment will be described with reference to the drawings. The program recorded in the non-volatile memory 203 of the image display apparatus 101 is loaded into the main memory 202 and executed by the CPU 201, thereby realizing the process.

A difference from the first exemplary embodiment in FIG. 5 will be described.

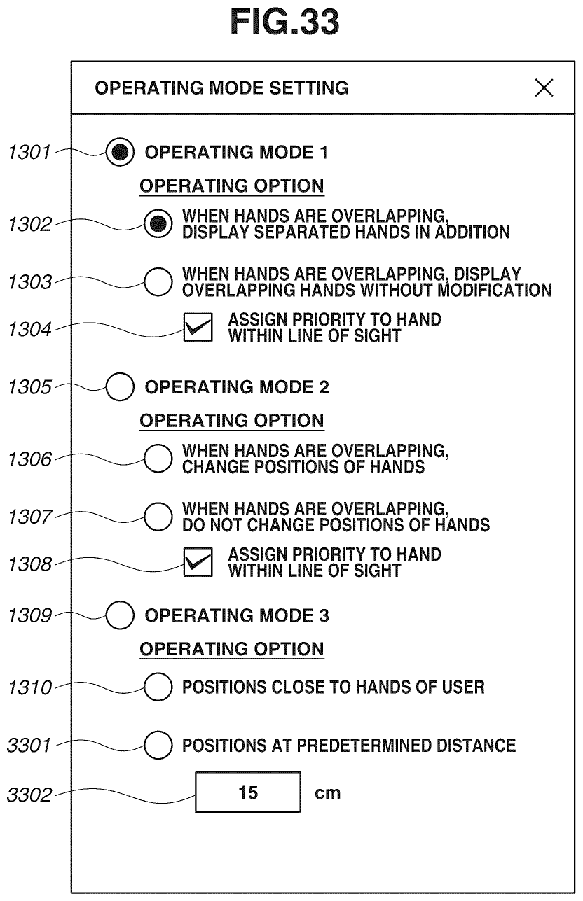

In step S501, the CPU 201 issues an instruction to display the operating mode setting screen, receives operating mode and option settings from the user, and stores the operating mode and option settings in the main memory 202. FIG. 33 illustrates an example of the operating mode setting screen.

A difference from the first exemplary embodiment in FIG. 6 will be described.

In step S601, the CPU 201 estimates the positions and orientations of the image display apparatus 101 and a cooking tool 2801 (a cutting board placed in front of the user) used by the user based on the video acquired from the imaging unit 207 and the image processing unit 208 and stores the results in the main memory 202. For example, by temporarily moving the image display apparatus 101 to a position where the entire cooking tool 2801 is visible, the relative positions of the image display apparatus 101 and the cooking tool 2801 are calculated.

In step S602, in a case where the hands of the user are on the cooking tool 2801, the CPU 201 estimates the positions and orientations of the hands based on the video acquired from the imaging unit 207 and the image processing unit 208.

A difference from the first exemplary embodiment in FIG. 7 will be described.

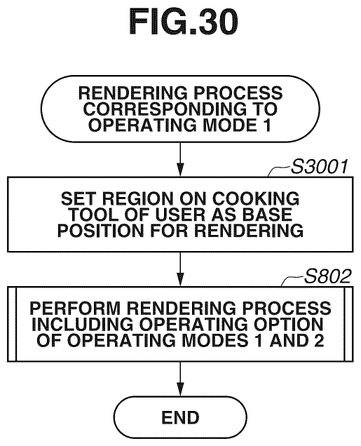

In step S702, the CPU 201 performs the rendering process corresponding to the operating mode 1 (for displaying at actual positions on the cooking tool). Details of the rendering process corresponding to the operating mode 1 will be described below with reference to FIG. 30.

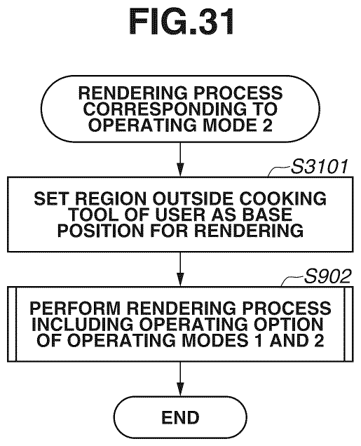

In step S703, the CPU 201 performs the rendering process corresponding to the operating mode 2 (for displaying at positions outside the cooking tool). Details of the rendering process corresponding to the operating mode 2 will be described below with reference to FIG. 31.

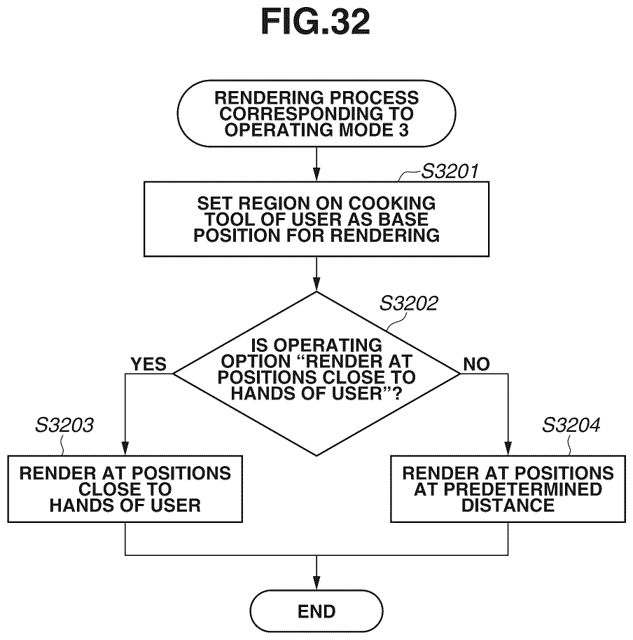

In step S704, the CPU 201 performs the rendering process corresponding to the operating mode 3 (for displaying at positions different from the actual positions on the cooking tool). Details of the rendering process corresponding to the operating mode 3 will be described below with reference to FIG. 32.

A difference from the first exemplary embodiment in FIG. 11 will be described.

In step S1101, the CPU 201 acquires the model data 2901 read in the main memory 202.

In step S1102, the CPU 201 refers to the acquired model data 2901 and determines whether the hands are overlapping. In a case where the hands are overlapping (YES in step S1102), the processing proceeds to step S1104. If not (NO in step S1102), the processing proceeds to step S1103.

In step S1103, the CPU 201 refers to the base position setting for rendering stored in the main memory 202 in step S3101 or S3201. In a case where the base position setting for rendering is on the cooking tool of the user, the hand CGs are rendered on the actual cooking tool of the user. At this time, the hand CG positions are controlled by referring to the position and orientation estimation results stored in step S601 and the hand positions specified by the model data 2901 acquired in step S1101 so that the hand positions specified by the model data 2901 correspond to the positions on the actual cooking tool.

In a case where the base position setting for rendering is outside the cooking tool of the user, the cooking tool CG and the hand CGs are rendered at positions at a predetermined distance from the cooking tool of the user. Examples of the predetermined distance include, but are not limited to, approximately 30 cm. However, this is merely one example and is not intended to be a limitation. The cooking tool CG and the hand CGs may be rendered at any position outside the cooking tool. For example, the cooking tool CG and the hand CGs may be rendered 30 cm behind the cooking tool. However, this is not a limitation.

The phrase “outside the cooking tool” refers to a state where the target is not present anywhere along a vertical direction in three-dimensional space. In such a case, the target is considered to be outside the cooking tool.

In step S1105, the CPU 201 performs normal display corresponding to step S1103 and further performs the process of separating the right-hand CG and the left-hand CG and displaying them individually. The acquired model data 2901 is referred to, and the position and shape of each of the overlapping right and left hands are acquired. Then, CGs for the separated overlapping right and left hands are generated and arranged on the cooking tool of the user. The separated right-hand and left-hand CGs are arranged at a distance of 5 cm from the boundary edges of the overlapping hand CGs.

FIG. 30 is a flowchart illustrating the rendering process corresponding to the operating mode 1 of the image display apparatus 101 according to the second exemplary embodiment. Details of the rendering process corresponding to the operating mode 1 in step S702 in FIG. 7 will be described with reference to FIG. 30.

In step S3001, the CPU 201 stores a region on the cooking tool of the user as a base position setting for CG rendering in the main memory 202.

FIG. 31 is a flowchart illustrating the rendering process corresponding to the operating mode 2 of the image display apparatus 101 according to the second exemplary embodiment. Details of the rendering process corresponding to the operating mode 2 in step S703 in FIG. 7 will be described with reference to FIG. 31.

In step S3101, the CPU 201 stores a region outside the cooking tool of the user as a base position setting for CG rendering in the main memory 202.

FIG. 32 is a flowchart illustrating the rendering process corresponding to the operating mode 3 of the image display apparatus 101 according to the second exemplary embodiment. Details of the rendering process corresponding to the operating mode 3 in step S704 in FIG. 7 will be described with reference to FIG. 32.

In step S3201, the CPU 201 stores a region on the cooking tool of the user as a base position setting for CG rendering in the main memory 202.

In step S3202, the CPU 201 refers to the operating option set in step S501 and determines the process to be performed next. In a case where the operating option is “render at positions close to the hands of the user” (YES in step S3202), the processing proceeds to step S3203. In a case where the operating option is “position at a predetermined distance” (NO in step S3202), the processing proceeds to step S3204.

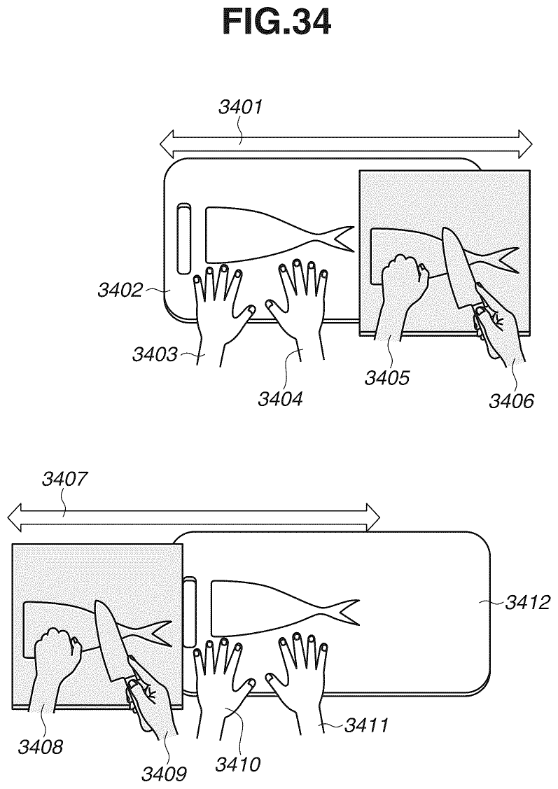

In step S3203, the CPU 201 performs control for CG rendering at positions close to the hands of the user. The positions of the hands of the user on the cooking tool, the position of the line of sight of the user, and the extent of the field of view of the user are considered, and the CGs are arranged at appropriate positions. FIG. 34 illustrates an example of the control for CG rendering at positions close to the hands of the user.

In a case where the hands of the user are on the cooking tool and within the field of view, hand CGs 3405 and 3406 are arranged on the right side of hands 3403 and 3404 of the user within the field of view. In a case where the CG positions become inappropriate due to a shift in the extent of the field of view of the user, CGs 3408 and 3409 are arranged on the left side of hands 3410 and 3411 of the user.

Examples of a case where the CG positions are determined to be inappropriate include a case where the CGs are no longer within the field of view due to a change in the extent of the field of view of the user and a case where the portion of the CGs that does not fit within the field of view increases. In such cases, arranging the CGs on the left side of the hands of the user increases the portion of the CGs that fits within the field of view. Thus, the CGs are controlled to be arranged on the left side. The distances between the CGs arranged on the right and left sides and the hands of the user are equal and are, for example, approximately 5 cm. However, this is merely one example and is not intended to be limited thereto.

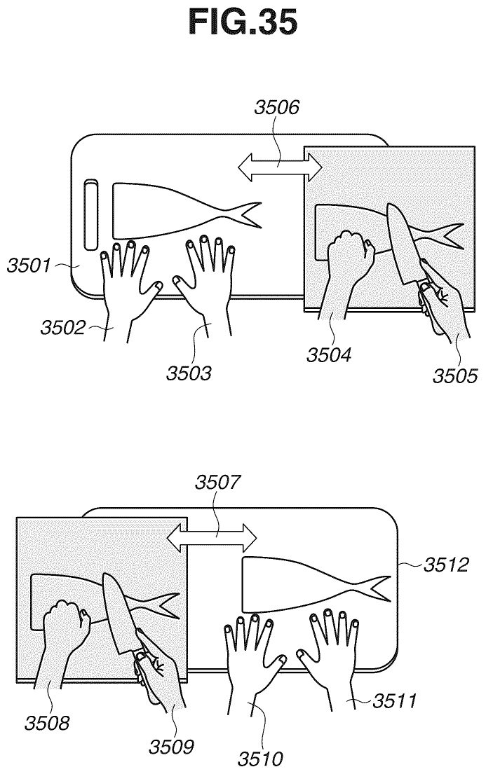

In step S3204, the CPU 201 performs control for CG rendering at positions at a predetermined distance. FIG. 35 illustrates examples of CG rendering at positions at a predetermined distance.

CGs are basically arranged on the right side of hands 3502 and 3503 of the user at a predetermined distance from the hands. However, in a case where it is determined that the left side is appropriate to the right side due to a shift in hands 3510 and 3511 of the user, hand CGs 3508 and 3509 are arranged on the left side of the hands 3510 and 3511 of the user at a predetermined distance from the hands 3510 and 3511.

Examples of a case where the left side is determined to be appropriate include a case where arranging the CGs on the left side increases the portion of the CGs that fits within the field of view whereas arranging the CGs on the right side results in half or more of the CGs extending outside the cooking tool. This is merely one example, and the left side may be determined to be appropriate due to other conditions.

FIG. 33 illustrates a display example of the operating mode setting screen in the flowchart in FIG. 5 in the second exemplary embodiment.

The numerical values 1301, 1305, and 1309 represent operating modes that can be selected in the first exemplary embodiment, and one of the plurality of operating modes can be selected. The operating options 1302 to 1304, 1306 to 1308, 1310 and 1311, or 3301 can be set for the selected operating mode. The user can configure these setting items as desired.

The operating option 3301 is one of the options for the operating mode 3 in the second exemplary embodiment and indicates “position at a predetermined distance”.

A box 3302 is used to input a value for the predetermined distance to be set in a case where the option “position at a predetermined distance” is selected.

FIG. 34 illustrates display examples in a case where control for rendering at positions close to the hands of the user is performed in the flowchart in FIG. 32. Fields of view 3401 and 3407 each represent an extent of the field of view of the user. Cooking tools 3402 and 3412 each represent the actual cooking tool used by the user. CGs 3405, 3406, 3408, and 3409 represent hand CGs. Hands 3403, 3404, 3410, and 3411 represent the actual hands of the user.

FIG. 35 illustrates display examples in a case where control for rendering at positions at a predetermined distance is performed in the flowchart in FIG. 32. Fields of view 3506 and 3507 each represent an extent of the field of view of the user. Cooking tools 3501 and 3512 each represent the actual cooking tool used by the user. CGs 3504, 3505, 3508, and 3509 represent hand CGs. Hands 3502, 3503, 3510, and 3511 represent the actual hands of the user.

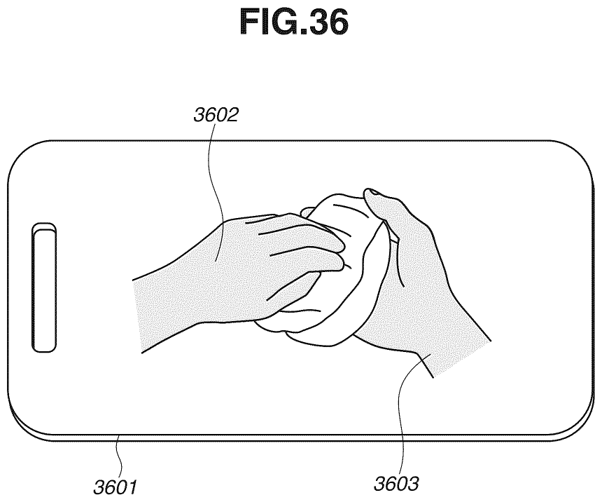

FIG. 36 illustrates a display example in a case where normal display is performed in the flowchart in FIG. 11. A cooking tool 3601 represents the actual cooking tool used by the user. CGs 3602 and 3603 represent hand CGs.

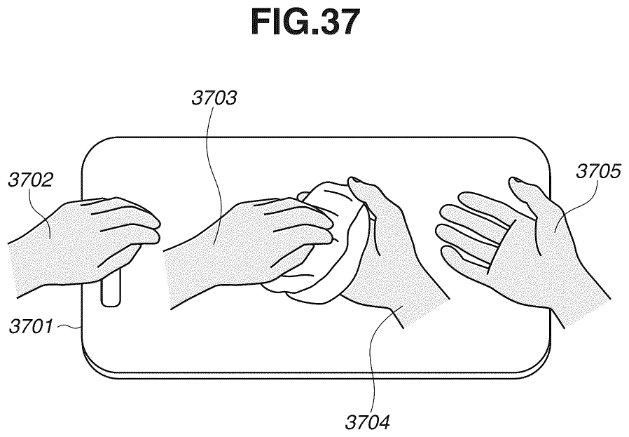

FIG. 37 illustrates a display example in a case where control is performed to separate overlapping hands and display the separated hands individually. A cooking tool 3701 represents the actual cooking tool used by the user. CGs 3702 and 3705 represent hand CGs after the overlapping hands are separated. CGs 3703 and 3704 represent unseparated overlapping hand CGs at their original positions.

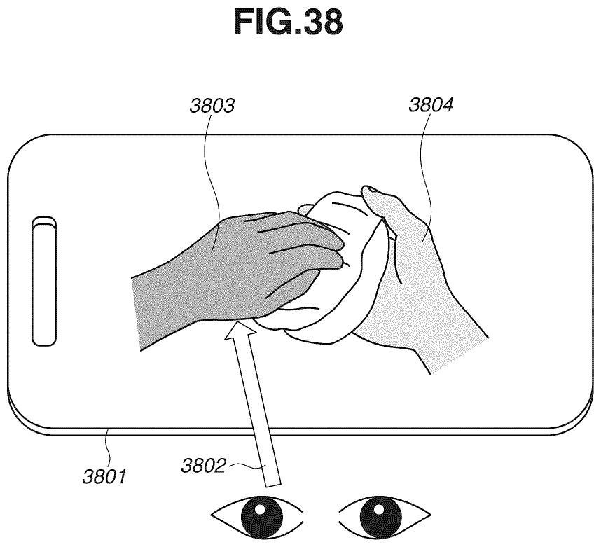

FIG. 38 illustrates a display example in a case where control is performed to display the hand within the line of sight with priority in the flowchart in FIG. 11. A cooking tool 3801 represents the actual cooking tool used by the user. A line of sight 3802 represents the line of sight of the user. A CG 3803 represents a hand CG (left hand) within the line of sight of the user. A CG 3804 represents the hand CG (right hand) outside the line of sight of the user.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-099181, which was filed on Jun. 19, 2024, and which is hereby incorporated by reference herein in its entirety.

What is claimed is:

1. An electronic apparatus comprising:
an imaging unit;
a display unit;
at least one processor; and
at least one memory, wherein the at least one memory stores instructions for causing the at least one processor and the at least one memory to:
estimate a position and orientation of a tool used by a user based on an image captured by the imaging unit;
acquire a movement of a hand of a person other than the user in a case where the tool is used by the person; and
display a computer graphic (CG) for a hand on the display unit based on the position and orientation and the movement,
wherein the CG for the hand is displayed at a position that does not overlap with a hand of the user on the tool.

2. The electronic apparatus according to claim 1, wherein the at least one memory further stores instructions for causing the at least one processor and the at least one memory to detect a line of sight of the user, and
change a display position of the CG for the hand based on a detection result of the detection of the line of sight of the user.

3. The electronic apparatus according to claim 1, wherein the at least one memory further stores instructions for causing the at least one processor and the at least one memory to operate in one of a plurality of operating modes,
wherein in a first operating mode, the CG for the hand is displayed at an actual position on the tool,
wherein in a second operating mode, the CG for the hand is displayed at a position outside the tool, and
wherein in a third operating mode, the CG for the hand is displayed at the position that does not overlap with the hand of the user on the tool.

4. The electronic apparatus according to claim 3, wherein in the first operating mode, the CG for the hand is overlayed and displayed such that a shape of the hand corresponding to the movement and a position of the hand on the tool correspond to the tool of the user in an actual video.

5. The electronic apparatus according to claim 3, wherein in the second operating mode, a CG for a hand and a tool are displayed so that a shape of the hand corresponding to the movement and a position of the hand on the tool are outside the tool of the user in an actual video.

6. The electronic apparatus according to claim 3, wherein in the third operating mode, in a case where right and left hands overlap during the movement acquired by the acquisition unit, a position of the right and left hands is changed to the position where the right and left hands do not overlap to display a CG for a hand and a tool.

7. The electronic apparatus according to claim 2, wherein the at least one memory further stores instructions for causing the at least one processor and the at least one memory to, in a case where right and left hands overlap during the movement, apply a rendering effect to the CG for the hand located at an end of the line of sight acquired and another rendering effect to the CG for the hand not located at the end of the line of sight, with the rendering effects differing from each other.

8. The electronic apparatus according to claim 2, wherein the at least one memory further stores instructions for causing the at least one processor and the at least one memory to take into account a position of the line of sight and a position and shape of both hands and display a CG for a hand and a tool at an appropriate position so that a shape of the hand corresponding to the movement and a position of the hand on the tool do not correspond to the movement on the tool of the user.

9. The electronic apparatus according to claim 3,
wherein one of the plurality of operating modes is set in advance by the user, and
wherein the at least one processor and the at least one memory operate in the set operating mode.

10. A method for controlling an electronic apparatus with an imaging unit and a display unit, the method comprising:
estimating a position and orientation of a tool used by a user based on an image captured by the imaging unit;
acquiring a movement of a hand of a person other than the user in a case where the tool is used by the person; and
displaying a computer graphic (CG) for a hand on the display unit based on the estimated position and orientation and the acquired movement,
wherein the CG for the hand is displayed at a position that does not overlap with a hand of the user on the tool.

11. The method for controlling the electronic apparatus according to claim 10, further comprising detecting a line of sight of the user,
wherein the displaying changes a display position of the CG for the hand based on a detection result from the detecting.

12. The method for controlling the electronic apparatus according to claim 10,
wherein the displaying operates in one of a plurality of operating modes,
wherein, in a first operating mode, the displaying displays the CG for the hand at an actual position on the tool,
wherein, in a second operating mode, the displaying displays the CG for the hand at a position outside the tool, and
wherein, in a third operating mode, the displaying displays the CG for the hand at the position that does not overlap with the hand of the user on the tool.

13. The method for controlling the electronic apparatus according to claim 12, wherein in the first operating mode, the displaying overlays and displays the CG for the hand such that a shape of the hand corresponding to the acquired movement and a position of the hand on the tool correspond to the tool of the user in an actual video.

14. The method for controlling the electronic apparatus according to claim 12, wherein, in the second operating mode, the displaying displays a CG for a hand and a tool such that a shape of the hand corresponding to the acquired movement and a position of the hand on the tool are outside the tool of the user in an actual video.

15. The method for controlling the electronic apparatus according to claim 12, wherein, in the third operating mode, in a case where a right hand and a left hand overlap during the acquired movement, the displaying changes positions of the right hand and the left hand at which the right hand and the left hand do not overlap to display a CG for a hand and a tool.

16. The method for controlling the electronic apparatus according to claim 11, wherein, in a case where a right hand and a left hand overlap during the acquired movement, the displaying applies a rendering effect to the CG for the hand located at an end of the detected line of sight and a rendering effect to the CG for the hand not located at the end of the line of sight, with the rendering effects differing from each other.

17. The method for controlling the electronic apparatus according to claim 11, wherein the displaying takes into account a position of the detected line of sight and a position and shape of both hands and displays a CG for a hand and a tool at an appropriate position so that a shape of the hand corresponding to the acquired movement and a position of the hand on the tool do not correspond to the movement on the tool of the user.

18. The method for controlling the electronic apparatus according to claim 12,
wherein one of the plurality of operating modes is set in advance by the user, and
wherein the displaying operates in the set operating mode.

19. A non-transitory computer-readable storage medium storing instructions for executing a method for controlling an electronic apparatus with an imaging unit and a display unit, the control method comprising:
estimating a position and orientation of a tool used by a user based on an image captured by the imaging unit;
acquiring a movement of a hand of a person other than the user in a case where the tool is used by the person; and
displaying a computer graphic (CG) for a hand on the display unit based on the estimated position and orientation and the acquired movement,
wherein the CG for the hand is displayed at a position that does not overlap with a hand of the user on the tool.
